(19) United States
(12) Patent Application Publication
(10) Pub. No.: US 2004/0241268 A1
(43) Pub. Date: Dec. 2, 2004

(54) Method for processing plastic particles and a plasticizing screw for a method of this type

(76) Inventors: Manfred Schaefer, Schoeffengrund (DE); Volker Jaehrling, Seeheim Jugenheim (DE)

Correspondence Address: FLYNN THIEL BOUTELL & TANIS, P.C., 2026 RAMBLING ROAD, KALAMAZOO, MI, 49008-1699, US

(21) Appl. No.: 10/490,150

(22) PCT Filed: Jun. 13, 2002
(86) PCT No.: PCT/EP02/06494

(30) Foreign Application Priority Data
Sep. 24, 2001 (DE) 101 46 851.2

(51) Int. Cl. B29B 17/00

(52) U.S. Cl. 425/208; 425/217

(57) ABSTRACT

The aim of the invention is to improve the processing of plastic particles, in particular from shredded plastic waste, into a moulding mass that can be injection moulded and to improve their transport into injection moulding moulds. To achieve this, noxious fractions of the moulding mass are degasified and eliminated in a purification stage and a plasticizing screw designed for this purpose is configured in such a way, that an outlet leading to the environment is provided for the gases to be eliminated in a purification area with a reduced working pressure.

The invention relates to a method for processing plastic particles, in particular made of shredded plastic waste, into a moulding mass that can be injection moulded and for their transport into an injection moulding machine, with a plasticising screw, a screw helix which is located on a wave-shaped screw core arranged in a plasticising cylinder, wherein the plasticising screw, which in its longitudinal direction has a multitude of sequential working zones, comprises at least one inlet- and compression area for drawing in the plastic particles from a filler funnel and for their technological processing to a homogeneous moulding mass, as well as a conveying area for conveying the said homogeneous moulding mass that can be injection moulded, into an outlet aperture which leads into the injection moulding machine. The invention further relates to a plasticising screw for injection moulding comprising a screw helix which is located on a wave-shaped screw core arranged in a plasticising cylinder, wherein the screw core along the entire length of the plasticising screw comprises several working zones, namely an inlet- and compression area for drawing in plastic particles from a filler funnel and for their technological processing to a homogeneous moulding mass, and a conveying area for conveying the homogeneous moulding mass, that can be injection moulded, into an outlet aperture leading into an injection moulding machine.

A method of this type including the associated plasticising screw is described in detail in printed patent specification DE 42 38 277 C2. Under the influence of pressure and temperature, such a plasticising screw transforms the plastic particles in a sequence of working zones into a moulding mass that can be injection moulded, which moulding mass can be fed to an injection moulding machine where it can be directly processed. While the process heat required for this method in part has to be supplied, the pressure relationships within the plasticising screw are above all determined by the geometry of the screw, in particular by increasing and/or decreasing the free volume which is available to the plastic within the plasticising cylinder. To this effect, it is for example possible to vary the diameter of the screw core in the direction of conveyance. In this way it has become possible, in a purely mechanical work step, to transform plastic particles conveyed into a filler funnel to a moulding mass that can be injection moulded, irrespective of whether shredded waste or new materials are involved.

Plastic waste contributes undesirable fractions to this method. For example, hygroscopic plastics contain water which will need to be removed from the plastic particles in a preceding drying process which is time consuming and expensive, whereby remaining residual humidity cannot be excluded. In this process, other undesirable admixtures are usually not eliminated; this includes above all components of paints and solvents, as well as remaining monomers, all of which have remained in the plastic materials and which reduce the quality of the finished products and can for example affect their surface finish and/or can lead to damaging deposits on the injection moulds used (some of which are very expensive), thus reducing their service life.

It is the object of the invention to overcome these deficiencies and in so doing to remove in a continuous operation any undesirable admixtures in the moulding mass made from the plastic particles before said admixtures reach the injection moulding process.

According to the invention, the object is first met by a method of the type described in more detail in the introduction, in which method a purification area is provided between the inlet/compression area and the conveying area, in which purification area the moulding mass, which has already at least been partly homogenised, is purified by degasification, with interfering components in the moulding mass being eliminated in a gaseous form, wherein in particular water, paints, solvents and monomers or similar fractions can be eliminated as gases from the moulding mass. Incorporating a degasification stage directly in the conversion process taking place within the plasticising screw ensures that said conversion process can keep going continuously while at the same time the moulding mass is being purified. In this way the interfering admixtures in the plastic particles or in the injection-mouldable moulding mass do not have to be removed, either before or after this point, in a discontinuous process, or in the alternative, there is no need to accept their negative effect on the quality of the finished product.

It is best if, in the purification area, the fractions which have been dissolved out of the moulding mass by means of degasification are removed from the plasticising cylinder before said moulding mass is conveyed to the conveying area. To this effect it is particularly advantageous if the pressure in the purification area of the plasticising screw is lowered to such an extent that no further paste-like components of the moulding mass are discharged from the plasticising cylinder together with the gases. In this way, removal of the degasified components is particularly simple, with said components for example being able to be led directly to an exhaust system, without parts of the moulding mass being taken along as well.

Furthermore, a preferred embodiment of the process according to the invention consists of a characteristic temperature gradient or a specified temperature being allocated to each of the sequential detailed process steps taking place in the working zones, wherein said temperature gradient or specified temperature is selected independently of the temperature gradients during the respective preceding and/or subsequent process step. In this way, temperature control can be exactly matched to the transformation process within the plasticising screw and to the type of the plastic materials used and their possible admixtures which are to be eliminated. Temperature control can be designed as a program control system and can be computer-controlled so that the entire process runs relatively automatically. In this way it is possible to almost completely remove undesirable fractions from the moulding mass, to significantly improve the quality of the products made from the moulding mass in the injection moulding machine, and to increase the service life of the required high-value injection moulds without having to accept a loss in quality.

Furthermore, the object of the invention is solved by a plasticising screw in which in a purification area between the inlet-/compression area and the conveying area an outlet for the gases to be removed is provided on the plasticising cylinder, with said outlet preferably in a simple way connecting the interior of said plasticising cylinder with a space of lower pressure, for example leading to the environment so that when necessary the gases can be led away with little effort and can be eliminated without causing any damage. A pressure reduction in the feed area of the outlet can be simply achieved in that the diameter of the screw core is reduced in the purification area, with an annular space being formed whose volume preferably exceeds to a considerable extent that of the preceding volume space that was available to the moulding mass. This ensures that the paste-like moulding mass remains entirely in the area of the plasticising screw without even partially being moved along by the gases issuing through the outlet. The ramming force necessary for conveying the moulding mass from the outlet aperture of the plasticising screw is obtained in that within the conveying area the diameter of the screw core is increased again so that the volume space available to the moulding mass is reduced again. Because of the dynamic conveyance of the moulding mass by the plasticising screw, there is no back draught due to the low pressure in the purification area.

It is expedient if the purification area essentially is available for the purpose of separating the undesirable admixtures, which have already been degasified, from the moulding mass. For this reason, a particularly advantageous embodiment of the plasticising screw according to the invention is characterised in that within the inlet- and compression area, just before the purification area, the diameter of the screw core is reduced and an annular space is formed whose volume preferably exceeds to a considerable extent the volume that was available to the moulding mass in the preceding space, so that degasification of the moulding mass can take place in this space already, either in whole or to a large extent.

A sensitive temperature gradient in the working zones of the plasticising screw, which gradient matches the particular plastic used, can be obtained if several or all working zones are associated with a separate heating system which is controllable independently of the other heating systems.

Finally, it has been shown that it is best if the conveying area which results in a pressure reduction ends in the direction of conveyance in front of the exit aperture in a working zone which is shaped as a coned tip, wherein the screw helix reaches as far as possible into said coned tip.

Overall, this provides a method and a device by means of which the above-described disadvantages of the state of the art if applicable are completely removed while at the same time the entire working process of producing and preparing an injectable moulding mass made of plastic particles both from new plastics and from shredded plastic waste is carried out in a continuous operation, with there no longer being any need for discontinuous degasification.

Any type of components can be produced from the plastic processed according to the invention. Many possible uses are therefore imaginable. However, the plastic processed according to the invention provides particularly good advantages in the case of coating of components by painting or immersion coating, as they are used in particular in the automotive industry. In order to carry out coating processes of acceptable quality, often components are necessary which are used as resources in securing the position of motor vehicle body parts during painting and/or coating in the immersion process. For example, when painting a motor vehicle body it is necessary for the boot lid to be held open by such a component so that painting of the inside of the boot can take place too.

Up to now, as a rule, correspondingly-shaped metal components have been used for securing the position of components to be painted. In order to prevent paint faults, it is necessary with these metal components to carefully clean them before using them in a further paint process, in this way removing all traces of paint applied during painting. However, such cleaning is time consuming and expensive. A large cost advantage can thus be achieved by substituting these metal components which plastic components which have been made from a plastic material processed according to the invention. It is no longer necessary to remove paint remnants individually after painting. Instead, the plastic components are comminuted after painting, and new plastic components are made from the resulting plastic particles. The processing method according to the invention removes the interfering paint residue from the plastic mass without great expenditure.

In order to hold the quality of the plastic at a level which is adequate for the respective application even after a multitude of cycles have been carried out, a respectively suitable partial quantity of new product can be admixed during each cycle to the plastic particles obtained by comminution.

Below, an embodiment of the invention is described in more detail with reference to the drawing. The following are shown, all in a diagrammatic, simplified view:

FIG. 1 a plasticising screw according to the invention;

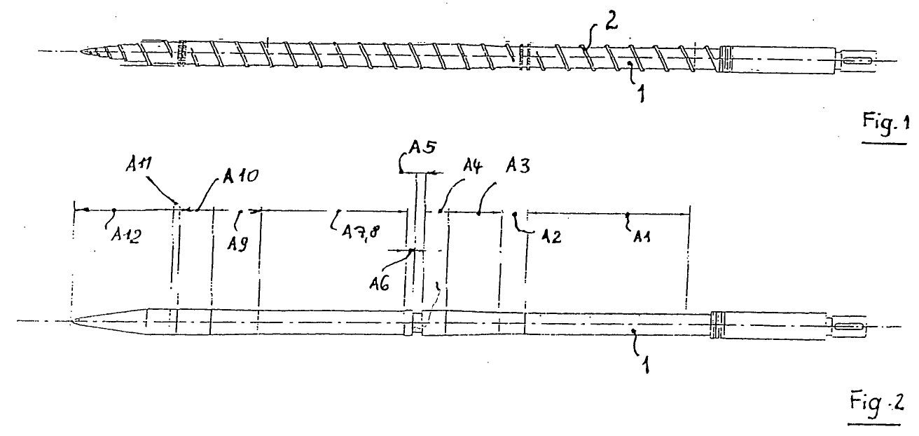

FIG. 2 the same plasticising screw, but simplified, with its working zones being shown;

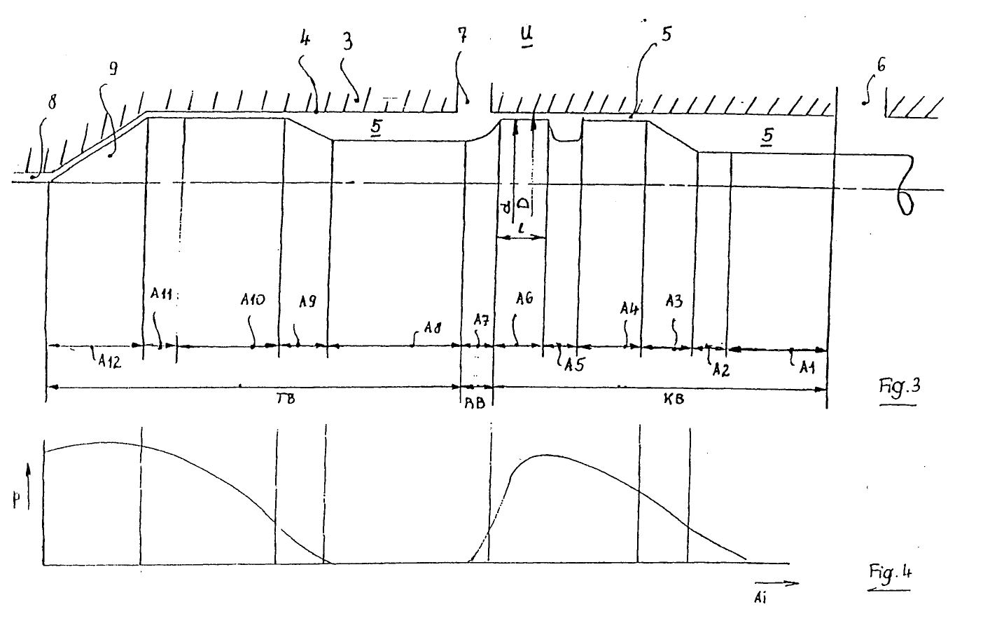

FIG. 3 an enlargement of the plasticising screw according to FIGS. 1 and 2; and

FIG. 4 the pressure gradient in the plasticising screw.

As shown in FIGS. 1 and 2, a plasticising screw according to the invention essentially comprises a screw core 1 with a screw helix 2 (FIG. 2) arranged on said screw core 1, and a plasticising cylinder 3 indicated in FIG. 3. Between the screw core 1 and the interior wall 4 of the plasticising cylinder 3 space volumes 5 of various dimensions remain whose size depends on the exterior diameter d of the screw core 1 and the interior diameter D of the plasticising cylinder 3, as well as on the length l along which said diameters d, D remain unchanged. The sizes have been provided in FIG. 3, as an example, for a working zone A6 of the plasticising screw which overall is divided into 12 working zones Ai (i=1 . . . 12).

A filler funnel 6 is indicated on the plasticising cylinder 3, with said filler funnel 6 being used for charging the plasticising screw with plastic particles of a specified confection, which in particular if they have been obtained from plastic waste may comprise undesirable admixtures which must not enter an injection moulding machine. To this purpose, these fractions such as water, paints, solvents or monomeric plastics and the like, which have been absorbed by the plastic, are eliminated from the homogeneous moulding mass in a working zone A7 designated as purification area RB, into which, in the embodiment shown, the plastic particles have already been transformed after having passed through a combined inlet- and compression area KB made up of a sequence of working zones A1-A6. The gases which accordingly arise in the working zone A7 are suctioned off from the interior space of the plasticising cylinder 3 into the space U by way of an outlet 7, and are subsequently disposed of. In a drawing-in device A1, the plastic particles first reach the working region of the plasticising screw, then pass through a first mixing zone A2 where they are highly compressed and homogenised in a compression zone A3 before they are freed of low-boiling components (when compared to the high-polymer plastic) in a degasifying zone AS delimited by two so-called metering zones A4 and A6. As has been explained, these low-boiling components to be removed can escape in the purification area RB. After another drawing-in device A8, there follow in the conveying area TB another compression zone A9 and another metering zone A10, wherein in the metering zones A4, A10, the respective preceding compression of the moulding mass is at least partially reversed. Finally, the moulding mass passes through a second mixing zone A11 and into the region of the coned tip 9 which ends in an outlet aperture 8 in the transition zone A12. In this transition zone A12, the moulding mass which is ready to be injection moulded is freed of any air inclusions, is partly recompressed, and is given a consistency which makes it particularly suitable for injection moulding. As a rule, the tip 9 is exchangeable so that tips 9 of different geometric shape can be exactly matched to a given plastic material.

FIG. 4 shows the pressure p in the moulding mass along the totality of the work zones Ai. Changes in pressure p depend on the geometry of the plasticising screw—diameter d of the screw core 1, pitch and lead of the screw helix 2, lengths l of the working zones Ai, interior diameter D of the plasticising cylinder 3, etc.—but they also depend on the respective temperatures which can be controlled by means of heating fields that are individually allocated to the respective working zones Ai. The details of such an arrangement as well as for example the program-dependent and if applicable computer-guided temperature control of these heating fields are within the sphere of knowledge of the average person skilled in the art and are therefore not shown in the drawing. FIG. 4 clearly shows that the pressure in the working zones A7, A8 is clearly reduced so that indeed the entire moulding mass remains within the plasticising screw, in spite of the outlet 7 located in this area.

### LIST OF REFERENCE CHARACTERS

1 Screw core

2 Screw helix

3 Plasticising cylinder

4 Interior wall

5 Volume space

6 Filler funnel

7 Outlet

8 Outlet aperture

9 Tip

d Exterior diameter, diameter

D Interior diameter, diameter

l Length (of a working zone)

Ai=A1-A12 Working zones

A1 Drawing-in device

A2 (First) mixing zone

A3 Compression zone

A4 Metering zone

A5 Degasifying zone

A6 Metering zone

A7 Purification zone

A8 Drawing-in device

A9 Compression zone

A10 Metering zone

A11 (Second) mixing zone

A12 Transition zone

KB Inlet and compression area (A1-A6)

RB Purification area (A7)

TB Conveying area (AB-A12)

1. A method for processing plastic particles, in particular made of shredded plastic waste, into a moulding mass that can be injection moulded and for their transport into an injection-moulding machine, with a plasticising screw, a screw helix (2) which is located on a wave-shaped screw core (1) arranged in a plasticising cylinder (3), wherein the plasticising screw, which in its longitudinal direction has a multitude of sequential working zones (Ai; i=1 . . . 12), comprises at least one inlet- and compression area (KB) for drawing in the plastic particles from a filler funnel (6) and for their technological processing to a homogeneous moulding mass, as well as a conveying area (TB) for conveying the said homogeneous moulding mass that can be injection moulded, into an outlet aperture (8) leading into the injection moulding machine, characterised in that
a purification area (RB) is provided between the inlet/compression area (KB) and the conveying area (TB), in which purification area (RB) the moulding mass, which has already at least been partly homogenised, is purified by degasification, with interfering components in the moulding mass being eliminated in a gaseous form.

2. The method according to claim 1, characterised in that water, paints, solvents or monomers or similar fractions are eliminated in a gaseous form.

3. The method according to claim 1, characterised in that in the purification area (RB) the fractions which have been dissolved out of the moulding mass by means of degasification are removed from the plasticising cylinder (3) before said moulding mass is conveyed to the conveying area (TB).

4. The method according to claim 1, characterised in that the pressure in the purification area (RB) of the plasticising screw is lowered to such an extent that no further paste-like components of the moulding mass are discharged from the plasticising cylinder (3) together with the gases.

5. The method according to claim 1, characterised in that a characteristic temperature gradient or a specified temperature is allocated to each of the sequential detailed process steps taking place in the working zones (Ai), wherein said temperature gradient or specified temperature is selected independently of the temperature gradients during the respective preceding and/or subsequent process step.

6. A plasticising screw for injection moulding, comprising a screw helix (2) which is located on a wave-shaped screw core (1) arranged in a plasticising cylinder (3), wherein the screw core (1) along the entire length of the plasticising screw comprises several areas, each of which comprises several working zones (Ai), namely an inlet- and compression area (KB) for drawing in the plastic particles from a filler funnel (6) and for their technological processing to form a homogeneous moulding mass, and a conveying area (TB) for conveying the homogeneous moulding mass that can be injection moulded into an outlet aperture (8) leading into an injection moulding machine, characterised in that in a purification area (RB) between the inlet/compression area (KB) and the conveying area (TB) an outlet (7) for the gases to be removed is provided on the plasticising cylinder (3).

7. The plasticising screw according to claim 6, characterised in that the outlet (7) connects the interior of the plasticising cylinder (3) with a space (U) of lower pressure, for example with the environment.

8. The plasticising screw according to claim 6, characterised in that the diameter (d) of the screw core (1) is reduced in the purification area (RB), and an annular space is formed whose vo- volume preferably exceeds to a considerable extent that of the preceding volume space (5) that was available to the moulding mass.

9. The plasticising screw according to claim 6, characterised in that within the conveying area (TB) the diameter (d) of the screw core (1) is increased again, so that the volume space available to the moulding mass is reduced again.

10. The plasticising screw according to claim 6, characterised in that within the inlet- and compression area (KB), just before the purification area (RB), the diameter (d) of the screw core (1) is reduced and an annular space is formed whose volume preferably exceeds to a considerable extent that of the preceding volume space that was available to the moulding mass.

11. The plasticising screw according to claim 6, characterised in that several or all working zones (Ai) are associated with a separate heating system which is controllable independently of the other heating systems (Ai).

12. The plasticising screw according to claim 6, characterised in that in the direction of conveyance in front of the exit aperture (8) said plasticising screw ends in a working zone (A12) which is shaped as a coned tip (9), wherein the screw helix (2) reaches as far as possible into said tip (9).

13. A component for use as a resource when securing the position of automotive body parts during painting and/or immersion coating, characterised in that the component is made from plastic particles which have been processed according to a method according to claim 1.

14. The component according to claim 13, characterised in that after coating, the component is comminuted to form plastic particles from which subsequently components are produced again for use as resources when securing the position of automotive body parts during painting and/or immersion coating.

15. The component according to claim 14, characterised in that unprocessed plastic particles are admixed to the plastic particles.
